(19) United States
(12) Patent Application Publication
(10) Pub. No.: US 2025/0299006 A1
(43) Pub. Date: Sep. 25, 2025

(54) IMAGE FORMING APPARATUS, IMAGE INSPECTION METHOD, AND IMAGE INSPECTION SYSTEM

(71) Applicant: Takahiro KOYAMA, Tokyo (JP)

(72) Inventor: Takahiro KOYAMA, Tokyo (JP)

(73) Assignee: Ricoh Company, Ltd., Tokyo (JP)

(21) Appl. No.: 19/082,460

(22) Filed: Mar. 18, 2025

(30) Foreign Application Priority Data
Mar. 22, 2024 (JP) 2024-045902

(51) Int. Cl. G06K 15/02; G06K 15/00; G06T 7/00; H04N 1/00

(52) U.S. Cl. CPC G06K 15/027; G06K 15/005; G06T 7/0004; H04N 1/00824; G06T 2207/30144; H04N 2201/0094

(57) ABSTRACT

An image forming apparatus includes a printer, a reading sensor, a display, and circuitry. The printer produces a printed material. The reading sensor reads the printed material. The circuitry controls the reading sensor to read the printed material and generate a read image, compares the read image and a master image of the printed material, determines whether an image defect exists in the read image based on a comparison between the read image and the master image, determines whether the image defect is generated by a sensor defect in the reading sensor based on the comparison when the image defect exists in the read image, calculates a position of the sensor defect on the reading sensor, and controls the display to display the position and the read image on the display.

### CROSS-REFERENCE TO RELATED APPLICATIONS

This patent application is based on and claims priority pursuant to 35 U.S.C. § 119(a) to Japanese Patent Application No. 2024-045902, filed on Mar. 22, 2024, in the Japan Patent Office, the entire disclosure of which is hereby incorporated by reference herein.

### BACKGROUND

### Technical Field

The present disclosure relates to an image forming apparatus, an image inspection method, and an image inspection system.

### Related Art

Recently, a printing system that can determine whether an image printed on a sheet is good or bad has been developed. Such a printing system includes a printer printing the image on the sheet and an inspection device inspecting the image on the sheet while the sheet is conveyed. To inspect whether the image printed on the sheet is good or bad, the inspection device reads the image on the sheet conveyed and determines whether the image printed on the sheet is a normal image based on the read image.

### SUMMARY

The present disclosure described herein provides an image forming apparatus including a printer, a reading sensor, a display, and circuitry. The printer produces a printed material. The reading sensor reads the printed material. The circuitry controls the reading sensor to read the printed material and generate a read image, compares the read image and a master image of the printed material, and determines whether an image defect exists in the read image based on a comparison between the read image and the master image. When the image defect exists in the read image, the circuitry determines whether the image defect is generated by a sensor defect in the reading sensor based on the comparison, calculates a position of the sensor defect on the reading sensor, and controls the display to display the position and the read image on the display.

The present disclosure described herein also provides an image inspection method including printing a printed material, reading the printed material to generate a read image, comparing the read image and a master image of the printed material, and determining whether an image defect exists in the read image based on a comparison between the read image and the master image, determining whether the image defect is generated by a sensor defect in the reading sensor based on the comparison when the image defect exists in the read image, calculating a position of the sensor defect on the reading sensor, and displaying the position and the read image on the display.

The present disclosure described herein further provides an image inspection system including a printer, a reading sensor, a display, and circuitry. The printer produces a printed material. The reading sensor reads the printed material. The circuitry controls the reading sensor to read the printed material and generate a read image, compares the read image and a master image of the printed material, and determines whether an image defect exists in the read image based on a comparison between the read image and the master image. When the image defect exists in the read image, the circuitry determines whether the image defect is generated by a sensor defect in the reading sensor based on the comparison, calculates a position of the sensor defect on the reading sensor, and controls the display to display the position and the read image on the display.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a block diagram illustrating a configuration of a printer;

FIG. 3 is a block diagram illustrating a configuration of an inspection device;

FIG. 4 is a flowchart of processes of an image inspection performed by the inspection device of FIG. 2, including processes when a reading sensor defect occurs;

FIG. 5 is a flowchart of specific processes in step S506 in FIG. 4;

FIG. 6 is a flowchart of specific processes in step S601 in FIG. 5;

FIG. 7 is a view illustrating an example of a display screen to notify the reading sensor defect to a user in step S506 of FIG. 4;

FIG. 8A is a schematic view of an example of an abnormal image caused by an abnormality of a printer; and

FIG. 8B is a schematic view of an example of an abnormal image caused by a sensor defect.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an image forming apparatus, an image inspection method, and an image inspection system with reference to the drawings.

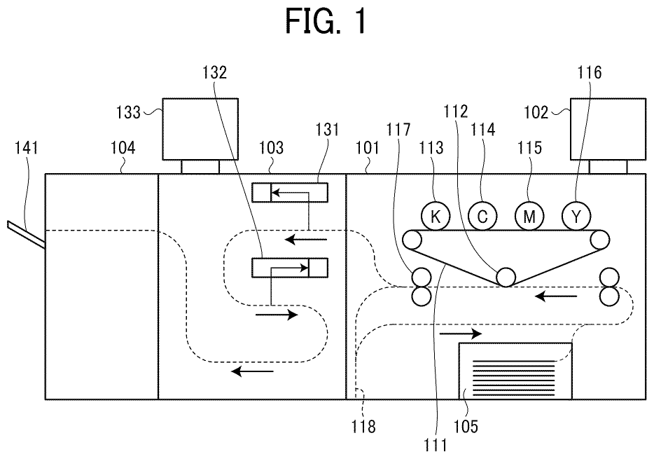

FIG. 1 is a schematic diagram illustrating the configuration of the image forming apparatus. The image forming apparatus includes a printer 101 and an operation panel 102 of the printer 101.

The printer 101 receives a print data of a print job including a print image such as a rasterized image processing (RIP) image by an image generation controller such as a digital front end (DFE) coupled to an external device or receives an instruction to execute a print job stored in the printer 101.

According to the print job, the printer 101 obtains a sheet from a sheet feeder 105 and conveys the sheet along a passage indicated by a dotted line in FIG. 1. The printer 101 includes photoconductor drums 113 to 116 forming black (K), cyan (C), magenta (M), and yellow (Y) toner images, respectively. These toner images are superimposed on a belt 111 to form a color toner image. A roller 112 transfers the color toner image onto the sheet conveyed. A roller 117 fixes the color toner image onto the sheet. In a single-sided printing mode, the printer 101 ejects the sheet to an inspection device 103 as it is. In a double-sided printing mode, the sheet is reversed on a reverse passage 118 so that another color toner image is transferred and fixed onto another side of the sheet. Finally, the sheet is ejected. In the following description, the color toner image and said another color toner image are referred to simply as the toner image or the image.

The inspection device 103 inspects the image formed as described above on the sheet output by the printer 101. The inspection device 103 includes an operation panel 133 as an operation unit. The operation panel 133 includes a display. The inspection device 103 may not include the operation panel 133. The operation panel 102 on the body of the printer may serve as the operation unit of the inspection device 103. Alternatively, a personal computer (PC) coupled to a local area network (LAN) may be used as the operation unit of the inspection device 103. The inspection device 103 includes reading sensors 131 and 132 to read images on both sides of the sheet ejected from the printer 101 and ejects the sheet after the reading sensors 131 and 132 read images. A stacker 104 stacks the sheets ejected from the inspection device 103 on an output tray 141.

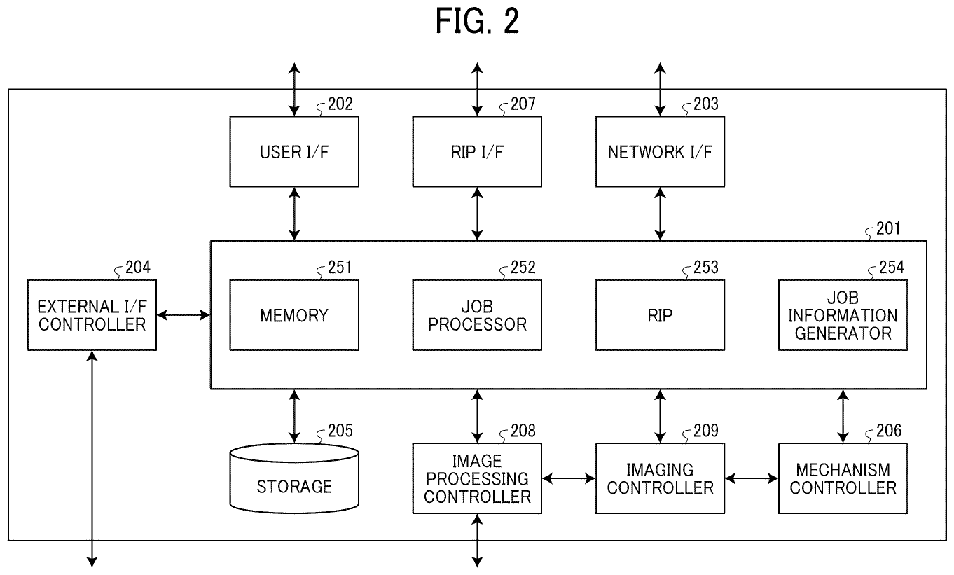

FIG. 2 is a block diagram illustrating the configuration of the printer 101. The printer 101 includes a system controller 201, a user I/F 202, a network I/F 203, an external I/F controller 204, a storage 205, a mechanism controller 206, a RIP I/F 207, an image processing controller 208, and an imaging controller 209.

The system controller 201 controls the overall operation of the printer 101. The system controller 201 includes a memory 251, a job processor 252, a rasterized image processor 253, and a job information generator 254.

The user I/F 202 couples the system controller 201 to the operation panel 102. The network I/F 203 couples the system controller 201 to a network such as a local area network (LAN). The external I/F controller 204 serves as an interface coupling the system controller 201 to other devices. The storage 205 includes a hard disk drive or another storage device. The mechanism controller 206 controls operations of the printer 101 such as sheet conveyance and a transfer process. The RIP I/F 207 transfers the RIP image to the image generation controller such as the DFE coupled to the external device. The image processing controller 208 controls the mechanism controller 206 to control the operation such as the transfer of the toner image. The imaging controller 209 controls image formation on a recording medium such as a sheet.

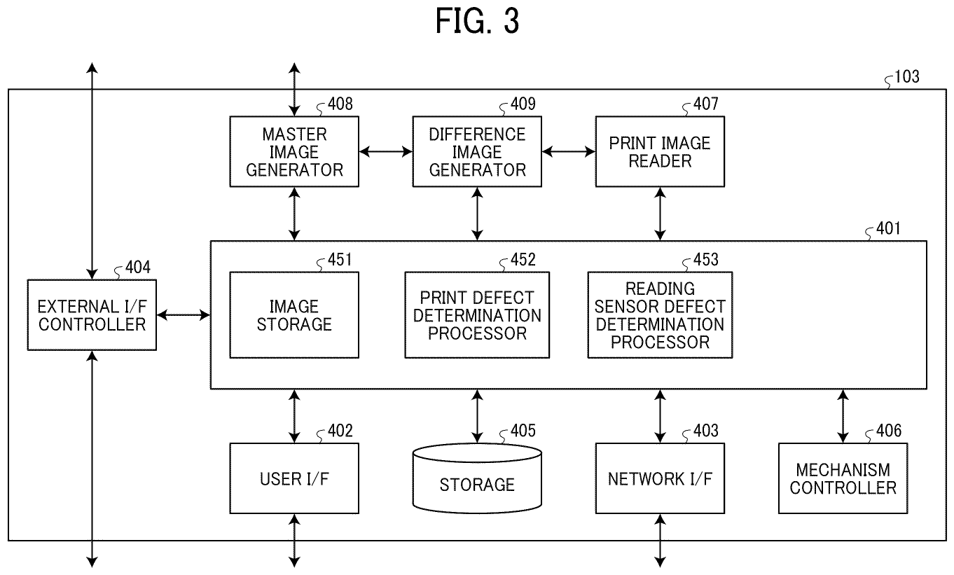

FIG. 3 is a block diagram illustrating the configuration of the inspection device 103. As illustrated in FIG. 3, the inspection device 103 includes a system controller 401, a user I/F 402, a network I/F 403, an external I/F controller 404, a storage 405, a mechanism controller 406, a print image reader 407, a master image generator 408, a difference image generator 409.

The system controller 401 that is circuitry controls the overall operation of inspection device 103. The user I/F 402 couples the system controller 401 to the operation panel 133. The network I/F 403 couples the system controller 401 to the network such as the LAN. The external I/F controller 404 serves as an interface coupling the system controller 401 to other devices. The storage 405 includes a hard disk drive or another storage device.

The mechanism controller 406 controls operations of the inspection device 103 such as sheet conveyance. The print image reader 407 is an example of an inspection target image acquisition unit that includes the reading sensors 131 and 132, reads a printed material (a print output) printed by the printer 101, and acquires an inspection target image. Specifically, the system controller 401 controls the reading sensor 131 or 132 to read the printed material printed by the printer 101 and generate the inspection target image that is a read image read by the reading sensor 131 or 132.

The master image generator 408 generates a master image (a correct image) to be compared with the inspection target image from the RIP image. In other words, the correct image is used by the printer to print the printed material.

The difference image generator 409 generates a difference image between the master image and the inspection target image.

The system controller 401 stores the inspection target image (the read image) and the difference image in an image storage 451 and notifies storing the read image and the difference image in the image storage 451 to a print defect determination processor 452 and a reading sensor defect determination processor 453.

The print defect determination processor 452 uses a print defect determination threshold set in advance for the difference image to determine whether an image defect exists on the inspection target image that is the read image. In other words, the print defect determination processor 452 is an example of a defect determiner that determines whether the state of the inspection target image is good or bad based on the master image and the inspection target image.

Similarly, the reading sensor defect determination processor 453 determines whether a sensor defect caused by dust attached to the reading sensor (the print image reader 407) exists on the inspection target image based on a reading sensor failure defect determination threshold set in advance with respect to the difference image. In other words, the reading sensor defect determination processor 453 is an example of a reading sensor failure determiner that determines whether the sensor defect is caused by the print image reader 407 based on the inspection target image. The reading sensor defect determination processor 453 in the system controller 401 determines whether the defect in the inspection target image is caused by the sensor defect in the reading sensor based on the read image in response to determining that the defect is in the inspection target image.

The system controller 401 is an example of a position calculator that calculates the position of the sensor defect caused by the print image reader 407 including the reading sensors 131 and 132. The system controller 401 is an example of a display controller that displays the calculated position together with the inspection target image. In other words, the system controller 401 controls the display of the operation panel 133 to display the position and the inspection target image that is the read image. The above-described configuration enables the user to reliably clean the reading sensors 131 and 132 when the user cleans of the reading sensors 131 and 132.

At this time, the system controller 401 may control the operation panel 133 to display the reading sensors 131 and 132 each having a scale for specifying a cleaning position of the print image reader 407 based on the calculated position. As a result, the user can reliably clean the reading sensors 131 and 132 when the user cleans the reading sensors 131 and 132 because the user can match the position of the defect displayed on the display of the operation panel 133 (UI) with the actual reading sensors 131 and 132. Alternatively, the system controller 401 may control the operation panel 133 to display the calculated position and the scale to indicate a cleaning position of the reading sensor. The system controller 401 is also an example of a cleaning notification unit that notifies that the reading sensors 131 and 132 are normally cleaned after the user cleans the reading sensors 131 and 132.

The system controller 401 stores the calculated position in the storage 405. The system controller 401 is an example of a determiner that determines whether the sensor defect caused by the reading sensor 131 or 132 occurs at the same position based on the position stored in the storage 405. The system controller 401 is an example of a notification unit that notifies the user that the sensor defect caused by the reading sensor 131 or 132 has occurred at the same position. If the failure of the reading sensor 131 or 132 is not solved, the system controller 401 determines that a fatal failure that the user cannot easily remove dust entering the hardware (HW) of the reading sensor occurs and can control the operation panel to display a service call at an appropriate timing. In the present embodiment, the system controller 401 controls the operation panel 133 to display the position and the inspection target image, but the present disclosure is not limited to this. The system controller 401 may send position data and inspection target image data to another device other than the image forming apparatus such as a personal computer (PC) or a mobile terminal to display the position and the inspection target image on the PC or the mobile terminal.

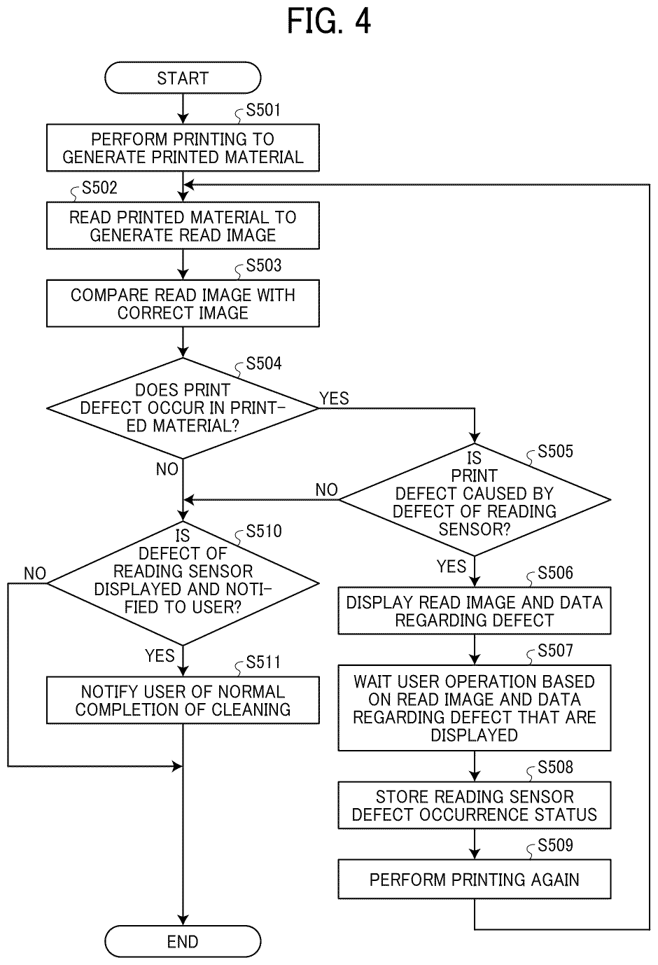

FIG. 4 is a flowchart of processes of an image inspection performed by the inspection device 103, including processes when the sensor defect that is a reading sensor failure occurs. In step S501, the printer 101 performs printing to make the printed material after the print job is input. In step S502, the inspection device 103 uses at least one of the reading sensors 131 and 132 as the print image reader 407 to read the printed material, and the system controller 401 stores the read image as the inspection target image in the storage 405. In step S503, the difference image generator 409 compares the master image that is the correct image with the inspection target image to generate the difference image.

In step S504, the print defect determination processor 452 determines whether a printing failure (the image defect) occurs in the inspection target image that is the read image based on the generated difference image. If no defect occurs (NO in step S504), the system controller 401 determines that the inspection target image is normal and, in step S510, determines whether the sensor defect of the reading sensor 131 or 132 is notified to the user based on the status in step S508, which is described below. If the sensor defect of the reading sensor 131 or 132 is not notified to the user (No in step S510), the system controller 401 ends processing.

If the print defect determination processor 452 determines that the printing failure occurs (Yes in Step S504), that is, an abnormal image occurs, the reading sensor defect determination processor 453 determines whether the determined failure is generated by the sensor defect that is a malfunction of the reading sensor 131 or 132 (Step S505). For example, dust on the reading sensor 131 or 132 causes the above-described malfunction. The dust such as paper dust on the reading sensor 131 or 132 causes a streaky abnormal image in the inspection target image.

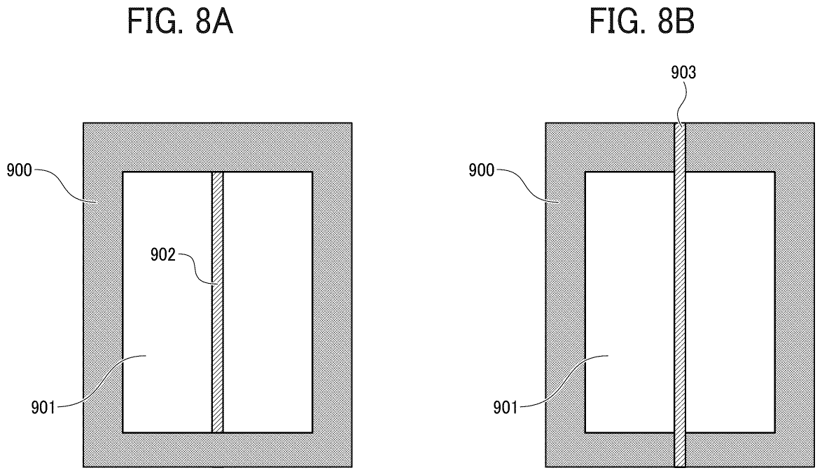

For example, the reading sensor defect determination processor 453 determines whether the determined failure is caused by the sensor defect that is the malfunction of the reading sensor 131 or 132 as follows. When the inspection device 103 uses at least one of the reading sensors 131 and 132 to read the printed material, the inspection device 103 uses at least one of the reading sensors 131 or 132 to read portions around the printed material as a background image. The system controller 401 stores the background image around the read image in the storage 405 in addition to the read image. The background image includes an image other than a printed material, such as a sheet conveyance guide. As illustrated in FIGS. 8A and 8B, a typical background image 900 is a black image because the amount of light reflected from an object other than the printed material is small. FIG. 8A is a schematic view of an example of an abnormal image 902 on a read image 901 caused by an abnormality of the printer 101. As illustrated in FIG. 8A, the abnormal image 902 on the read image 901 caused by the abnormality of the printer 101 does not occur in the background image 900. FIG. 8B is a schematic view of an example of an abnormal image 903 on the read image 901 and the background image 900 caused by dust on at least one of the reading sensors 131 or 132. As illustrated in FIG. 8B, the abnormal image 903 caused by the dust on the reading sensor 131 or 132 occurs in the background image 900 and is connected to the abnormal image in the read image 901. After the print defect determination processor 452 determines that the printing failure (the print defect) occurs in the printed material, the reading sensor defect determination processor 453 determines whether the abnormal image connected to the abnormal image in the read image is in the background image stored in the storage 405. If the abnormal image connected to the abnormal image in the read image is in the background image, the reading sensor defect determination processor 453 determines the determined failure is caused by the sensor defect that is the malfunction of the reading sensor 131 or 132 such as the paper dust on the reading sensor 131 or 132.

If the reading sensor defect determination processor 453 does not determine that the determined failure is caused by the sensor defect of the reading sensor 131 or 132 (No in step S505), the system controller 401 proceeds to step S510 and determines whether the sensor defect of the reading sensor 131 or 132 is notified to the user based on the status in step S508, which is described below. If the sensor defect of the reading sensor 131 or 132 is not notified to the user (No in step S510), the system controller 401 ends processing.

If the reading sensor defect determination processor 453 determines that the determined failure is caused by the sensor defect of the reading sensor 131 or 132 such as the defect caused by the dust on the reading sensor (Yes in step S505), the system controller 401 controls the operation panel 133 to display a position and size of the dust on the reading sensor 131 or 132 together with the read inspection target image on the display (step S506). This notifies the user that dust is on the reading sensor 131 or 132 and that cleaning is necessary.

In step S507, the user cleans the reading sensor 131 or 132 based on the information on the position and size of the dust on the reading sensor 131 or 132 and the inspection target image. In other word, the system controller 401 waits the above user's operation. In step S508, the system controller 401 stores a reading sensor defect occurrence status in the storage. The reading sensor defect occurrence status means that the dust was on the reading sensor 131 or 132. In step S511 described below, the system controller 401 uses the reading sensor defect occurrence status to notify the normal completion of cleaning to the user. After the user cleans the reading sensor 131 or 132, the user inputs the print job again, and the printer 101 executes printing again (step S509). The processing performed by the system controller 401 returns to step S502.

Again, in step S503, the print defect determination processor 452 compares the inspection target image with the correct image and, in step S504, determines whether the printing failure occurs. If no defect occurs (NO in step S504), the system controller 401 proceeds to step S510 and determines whether the sensor defect of the reading sensor 131 or 132 is notified to the user based on the status in step S508. Since the reading sensor failure occurrence status meaning that the failure of the reading sensor 131 or 132 occurs is stored in the storage as described above, the system controller 401 proceeds to step S511. At this time, since status changes from the reading sensor failure occurrence status in which the defect of the reading sensor 131 or 132 occurred to the status in which the sensor defect does not occur, the system controller 401 can determine that the user correctly cleaned the reading sensor 131 or 132. Based on the above, in step S511, the system controller 401 notifies the user of the normal completion of cleaning and ends the processing. In other words, the system controller 401 as the circuitry notifies that the sensor defect is recovered in response to determining that the sensor defect is not on the reading sensor this time after the circuitry determines that the sensor defect is in the reading sensor last time.

If the print defect determination processor 452 determines that the printing failure occurs (Yes in Step S504), the reading sensor defect determination processor 453 determines whether the determined failure is caused by the malfunction of the reading sensor 131 or 132 (Step S505). If the reading sensor defect determination processor 453 determines that the determined failure is not caused by the malfunction of the reading sensor 131 or 132 (No in step S505), the system controller 401 proceeds to step S510 and as described above, notifies the user of the normal completion of cleaning in step S511 and ends the processing. In other words, the system controller 401 as the circuitry notifies that the sensor defect is recovered in response to determining that the sensor defect is not on the reading sensor this time after the circuitry determines that the sensor defect is in the reading sensor last time.

If the reading sensor defect determination processor 453 determines that the determined failure is caused by the dust on the reading sensor 131 or 132 (Yes in step S505), the system controller 401 performs processes from step S506 to step S509 again. The inspection device 103 repeats the above-described processes until cleaning the reading sensor 131 or 132 removes the dust on the reading sensor 131 or 132. If the failure of the reading sensor 131 or 132 is not solved even after the inspection device 103 repeats the above-described processes, the system controller 401 determines that the reading sensor 131,132 is critically contaminated, that is, the dust is inside the reading sensor 131 or 132, which cannot be solved by the cleaning method presented to the user and notifies the user of the determination result.

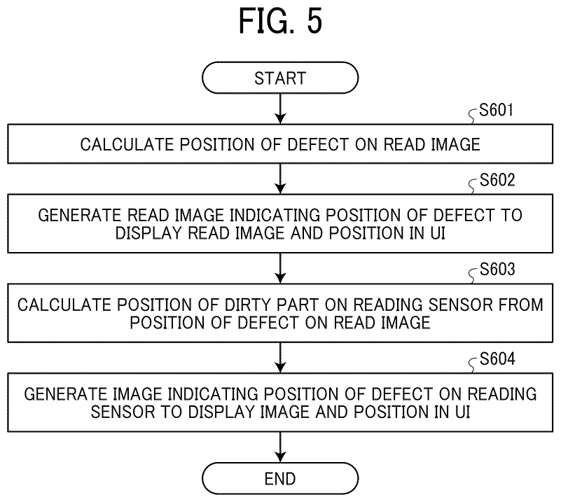

FIG. 5 is a flowchart of specific processes in step S506 in FIG. 4. In step S601, the system controller 401 calculates the position of the defect in the inspection target image that is caused by the sensor defect such as the dust on the reading sensor 131 or 132. In the method to calculate the position, data in step S504 to determine whether the defect occurs in the inspection target image (the read image) based on the difference image may be used. In step S602, the system controller 401 generates the read image indicating the position of the defect based on the calculated position of the defect to display the read image and the position of the defect in a user interface (UI) such as the display of the operation panel 133.

In step S603, the system controller 401 calculates the position of a dirty part of the reading sensor 131 or 132. The system controller 401 calculates the position of the dirty part of the reading sensor 131 or 132 based on the position of the defect on the read image and the standard such as the dimension of each of the mounted reading sensors 131 and 132. In step S604, the system controller 401 generates an image indicating the position of the defect on the reading sensor 131 or 132.

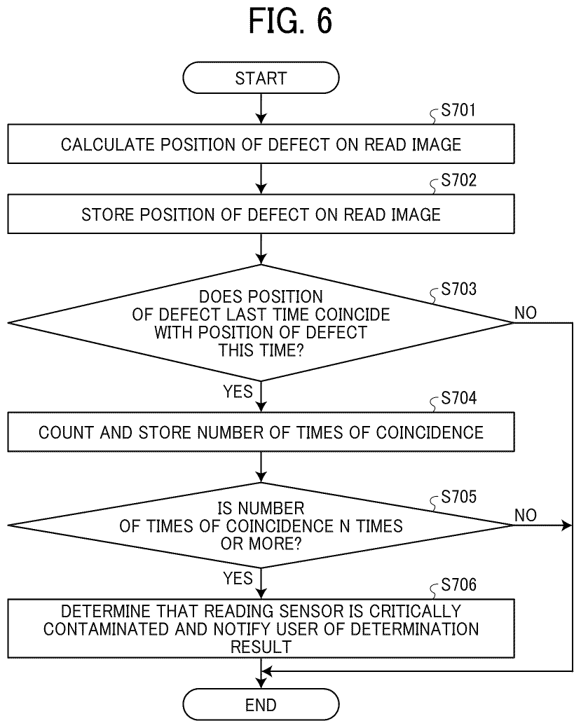

FIG. 6 is a flowchart of specific processes in step S601 in FIG. 5. In step S701, the system controller 401 calculates the position of the defect on the read image, which is the same as step S601 illustrated in FIG. 6. In step S702, the system controller 401 stores the calculated position of the defect.

In step S703, the system controller 401 determines whether the position of the defect stored last time coincides with the position of the defect stored this time. Note that the defect last time is determined as the sensor defect of the reading sensor 131 or 132, and the position is calculated and stored. If the stored position of the defect does not coincide with the position of the defect occurred this time (No is step S703), the system controller 401 ends the processing. If the position of the defect stored last time coincides with the position of the defect occurred this time (Yes in step S703), the system controller 401 counts and stores the number of times of coincidence in which the position of the defect stored last time coincides with the position of the defect occurred this time (step S704).

In step S705, the system controller 401 determines whether the number of times of coincidence is equal to or larger than a predetermined number of times N. Since the above-described determination condition varies depending on the defect determination algorithm, the HW standard of the reading sensors 131 and 132, and the installation position, the determination condition is determined by preliminary evaluation. In addition, the system controller 401 is configured to receive a changed determination condition. If the number of times of coincidence is less than the predetermined number of times (No in step S705), the system controller 401 ends the processing. If the number of times of coincidence is equal to or larger than the predetermined number of times N (Yes in step S705), the system controller 401 determines that the reading sensor 131, 132 is critically contaminated, that is, the dust is inside the reading sensor 131 or 132, which cannot be solved by the cleaning method presented to the user and notifies the user of the determination result (step S706).

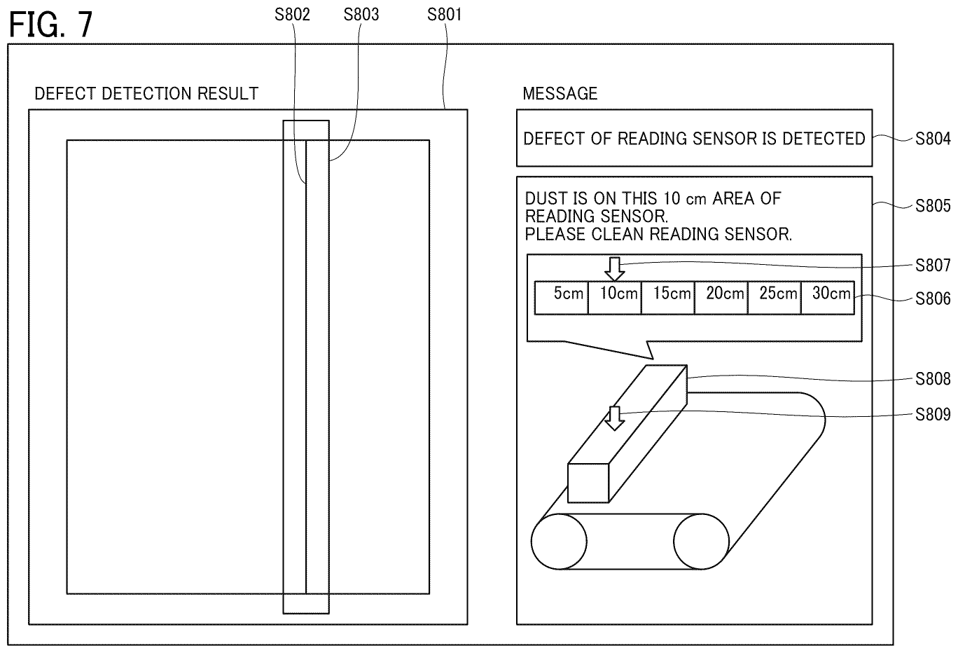

FIG. 7 is a view illustrating an example of a display screen to notify the defect to the user in step S506 of FIG. 4. The system controller 401 controls the operation panel 133 to display an image 801 indicating the position of the defect of the reading sensor 131 or 132 in the inspection target image (the read image). The system controller 401 controls the operation panel 133 to display the defect 802 of the reading sensor 131 or 132 in the image 801. The system controller 401 controls the operation panel 133 to display a display frame 803 indicating the position of the defect on the reading sensor 131 or 132 to the user in the image 801. The display method for notifying the user of the defect on the reading sensor 131 or 132 is not limited to this display method as long as the defect on the reading sensor 131 or 132 can be indicated to the user.

The system controller 401 controls the operation panel 133 to display a message 804 that notifies the user of the occurrence of the defect on the reading sensor 131 or 132. In addition, the system controller 401 controls the operation panel 133 to display a notification 805 prompting cleaning the reading sensor 131 or 132 in response to the occurrence of the defect on the reading sensor 131 or 132. At this time, the system controller 401 adds the position of the dirty part of the reading sensor 131 or 132 calculated in step S604 of FIG. 6 to the message of the notification 805.

The system controller 401 controls the operation panel 133 to display images 807 to 809 specifically indicating the position of the dirty part on the reading sensor 131 or 132. The image 807 includes a mark indicating specific position of the dirty part on the reading sensor 131 or 132 calculated in step S604 of FIG. 6. The mark is displayed together with the size (the scale) 806 of the reading sensor 131 or 132. The scale 806 in the image is one example, and the display content is not limited to this. The system controller 401 controls the operation panel 133 to display an image 808 indicating the actual reading sensor 131 or 132 and a mark 809 indicating the position of the dirty part on the reading sensor 131 or 132 corresponding to the position of the dirty part in the image 807.

As described above, according to the image forming apparatus of the present embodiment, the user can more reliably clean the reading sensor 131 or 132.

Although, in the above embodiments, the description is provided is of a case in which the image forming apparatus according to the embodiments is a multifunction peripheral having at least two of the copier function, the printer function, the scanner function, and the facsimile function, this is merely one example. In another example, aspects of this disclosure are applicable to any image forming apparatus such as a copier, a printer, a scanner, or a facsimile machine.

Aspects of the present disclosure are, for example, as follows.

### First Aspect

In a first aspect, an image forming apparatus includes a printer, an inspection target image acquisition unit, a defect determiner, a reading sensor failure determiner, a position calculator, and a display controller. The printer prints a printed material. The inspection target image acquisition unit reads the printed material to acquire an inspection target image. The defect determiner determines whether the state of the printed material is good or bad based on the inspection target image and a correct image to be compared with the inspection target image. When the defect determiner determines that the state of the printed material is bad, the reading sensor failure determiner determines whether the bad state of the printed material caused by a defect of the inspection target image acquisition unit based on the inspection target image. The position calculator calculates position data of the defect of the inspection target image acquisition unit. The display controller displays the position data calculated by the position calculator together with the inspection target image.

### Second Aspect

In a second aspect, the display controller in the image forming apparatus according to the first aspect displays a reader having a scale for specifying a cleaning position of the inspection target image acquisition unit.

### Third Aspect

In a third aspect, the display controller in the image forming apparatus according to the second aspect displays the position data and the scale as the cleaning position of the inspection target image acquisition unit.

### Fourth Aspect

In a fourth aspect, the image forming apparatus according to any one of the first to third aspects includes a cleaning notification unit that notifies that the inspection target image acquisition unit is normally cleaned after the inspection target image acquisition unit is cleaned.

### Fifth Aspect

In a fifth aspect, the image forming apparatus according to any one of the first to fourth aspects further includes a storage, a determiner, and a notification unit. The storage stores the position data of the defect of the inspection target image acquisition unit. The determiner determines whether the defect occurs at the same position based on the position data stored in the storage. when the determiner determines that the defect occurs at the same position, the notification unit notifies the user that the sensor defect has occurred at the same position.

### Sixth Aspect

In a sixth aspect, an image inspection method performed by an image forming apparatus including an inspection target image acquisition unit that reads a printed material printed by a printer to acquire an inspection target image includes the following steps. The first step is determining whether the state of the printed material is good or bad based on the inspection target image and a correct image to be compared with the inspection target image. The second step is, when it is determined that the state of the printed material is bad, determining whether the bad state of the printed material is caused by a defect of the inspection target image acquisition unit based on the inspection target image. The third step is calculating position data of the defect of the inspection target image acquisition unit. The fourth step is displaying the calculated position data together with the inspection target image.

### Seventh Aspect

In a seventh aspect, an image inspection system includes a printer, an inspection target image acquisition unit, a defect determiner, a reading sensor failure determiner, a position calculator, and a display controller. The printer prints a printed material. The inspection target image acquisition unit reads the printed material to acquire an inspection target image. The defect determiner determines whether the state of the printed material is good or bad based on the inspection target image and a correct image to be compared with the inspection target image. When the defect determiner determines that the state of the printed material is bad, the reading sensor failure determiner determines whether the bad state of the printed material caused by a defect of the inspection target image acquisition unit based on the inspection target image. The position calculator calculates position data of the defect of the inspection target image acquisition unit. The display controller displays the position data calculated by the position calculator together with the inspection target image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a printer to produce a printed material;
a reading sensor to read the printed material;
a display; and
circuitry configured to:
control the reading sensor to:
read the printed material; and
generate a read image;
compare the read image and a master image of the printed material;
determine whether an image defect exists in the read image based on a comparison between the read image and the master image;
determine whether the image defect is generated by a sensor defect in the reading sensor based on the comparison when the image defect exists in the read image;
calculate a position of the sensor defect on the reading sensor; and
control the display to display the position and the read image on the display.

2. The image forming apparatus according to claim 1,
wherein the circuitry is further configured to control the display to display, on the display:
the reading sensor; and
a scale indicating the position of the sensor defect on the reading sensor.

3. The image forming apparatus according to claim 2,
wherein the circuitry is further configured to control the display to display:
the scale; and
the position of the sensor defect on the reading sensor,
to indicate a cleaning position of the reading sensor on the display.

4. The image forming apparatus according to claim 1,
wherein the circuitry is further configured to:
determine that the sensor defect exists in the reading sensor as a first determination;
determine that the sensor defect does not exist in the reading sensor as a second determination; and
output a notification that the sensor defect is recovered in response to the second determination after the first determination.

5. The image forming apparatus according to claim 1, further comprising:
a storage;
wherein the circuitry is further configured to:
store the position of the sensor defect on the reading sensor in the storage;
determine whether the sensor defect exists at the same position stored in the storage; and
control the display to display that the sensor defect exists at the same position.

6. An image inspection method comprising:
printing a printed material;
reading the printed material to generate a read image;
comparing the read image and a master image of the printed material;
determining whether an image defect exists in the read image based on a comparison between the read image and the master image;
determining whether the image defect is generated by a sensor defect in a reading sensor based on the comparison when the image defect exists in the read image;
calculating a position of the sensor defect on the reading sensor; and
displaying the position and the read image on the display.

7. An image inspection system comprising:
a printer to produce a printed material;
a reading sensor to read the printed material;
a display; and
circuitry configured to:
control the reading sensor to:
read the printed material; and
generate a read image;
compare the read image and a master image of the printed material;
determine whether an image defect exists in the read image based on a comparison between the read image and the master image;
determine whether the image defect is generated by a sensor defect in the reading sensor based on the comparison when the image defect exists in the read image;
calculate a position of the sensor defect on the reading sensor, and
control the display to display the position and the read image on the display.
